(19) United States
(12) Patent Application Publication
(10) Pub. No.: US 2022/0414124 A1
(43) Pub. Date: Dec. 29, 2022

(54) AUTOMATED MATCHING AND TRANSFER OF HUMAN THOUGHTS USING DATASETS WITH TAG:VALUE PAIRS

(71) Applicant: Charles J. Kulas, San Francisco, CA (US)

(72) Inventor: Charles J. Kulas, San Francisco, CA (US)

(21) Appl. No.: 17/850,863

(22) Filed: Jun. 27, 2022

Related U.S. Application Data
(60) Provisional application No. 63/215,517, filed on Jun. 27, 2021.

(51) Int. Cl. G06F 16/28

(52) U.S. Cl. CPC G06F 16/285

(57) ABSTRACT

Embodiments provide for automated transfer of thoughts. For example, recommendations can be obtained for a user who defines a mindset using tag:value pairs. The tag:value pairs are referred to as “thoughts” and in one application the thoughts can be ratings of topics or items in which a user is interested (an “interest definition”). The interest definitions can be used to identify other existing content in which the user may be interested. Sources of content, such as an author, company; generated or derived data, etc.; can be selected by, or matched up with, the user based on the interest definitions so that as the source creates, or “posts,” new information, the interested user can be directed to the new posts. Given a user's interests, it is also possible to filter unwanted content, such as content in which the user is not likely to be interested; or from sources that create content that the user finds uninteresting, useless, inflammatory or otherwise unwanted.

### CROSS REFERENCES TO RELATED APPLICATIONS

This application claims the benefit of U.S. Provisional Patent Application Serial No. 63/215,517, entitled ONLINE AFFINITY DEFINITION, DISCOVERY AND CONTENT FILTERING, filed on Jun. 27, 2021, which is hereby incorporated by reference as if set forth in full in this application for all purposes.

### SUMMARY

With so much information, and misinformation, available online it is useful to develop methods and systems to help a user define their interests. Once defined, the interest definitions can then be used to identify existing content in which the user may be interested. Also, sources of content, such as an author, company; algorithm to generate or derive data, etc.; can be selected by, or matched up with, the user based on the interest definitions so that as a source creates, or “posts,” new information, the interested user can be directed to the new posts.

Given a user's interest definitions, it is also possible to filter unwanted content, such as content in which the user is not likely to be interested; or content that the user would find uninteresting, useless, inflammatory or otherwise unwanted.

One implementation provides a method for creating an interest definition in the form of a data record including tag+value pairs. The data record can be used in affinity matching to provide a user with of-interest information. The method comprising: creating a plurality of tag:value pairs wherein each tag:value pair includes a tagname naming an item and a value that assigns a level of the user's affinity for the item.

Another implementation provides a method for alerting a user when of-interest content is available online. The method comprising: using interest definitions to identify a source mindset that has a high affinity to a user's mindset; determining that a source associated with the source mindset has posted new content online; and alerting the user that the new content has been posted online.

Another implementation provides a method for reducing unwanted content from a user's online experience, the method comprising: using interest definitions to identify a source mindset that has a low affinity to a user's mindset; determining that content online is from a source associated with the source mindset; and reducing a viewability of low-affinity content.

Another implementation provides a method for automating transfer of thoughts, the method comprising: creating a first mindset with a plurality of thoughts, wherein each thought includes a tag:value pair; matching the first mindset with a second mindset, wherein the second mindset has a commonality with at least a portion of the first mindset's thoughts; identifying advisor mindsets of the second mindset, wherein an advisor mindset includes at least one commonality of thoughts with the second mindset; accepting a signal from a user input device to permit a user associated with the first mindset to selectively accept or reject the advisor mindsets; and using the accepted advisor mindsets to refer thoughts to the user.

### BRIEF DESCRIPTION OF THE DRAWINGS

FIG. 1 illustrates examples of data records that can be used in various implementations;

FIG. 2 illustrates advisor and listener mindsets, and how a user can accept or reject advisor mindsets; and

FIG. 3 is a block diagram that illustrates basic components of an example computer system.

### DETAILED DESCRIPTION OF IMPLEMENTATIONS

Various implementations allow a user to define their interests in an efficient and flexible data format referred to here as a “mindset.”. In one implementation, a mindset is a collection of tag:value pairs where the value provides a rating of the user's affinity to a subject, idea or other item. The user's affinity (i.e., “value’) toward the item named in the tag can take on many different forms, such as a simple “yes” or “no;” “positive” or “negative;” “like” or “don't like;” etc. The value can also be a range of numbers such as a “star” value of from 1 to 5, where 5 is the best. The value can be a range from 1-10 or can be any other range or set of numbers or objects. Any other suitable valuation can be used including strings, text (single words, phrases, etc.), numbers, expressions, data structures, meta data, etc.

Similarly, a tag can express an object, place, brand, concept, idea or other item in any feasible manner. Typically, a tag can be the name of a thing or an action. For example, a title of a movie or a name of a person can be a tag. Using an example of a movie title such as “The Conjuring” as the tag, a value associated with this tag can be “5” to represent that a user associated with this tag:value pair likes the movie (assuming “5” indicates a high affinity for the movie). Many other items can be the subject of a valuation in this manner. For example, any of the popular tags used in online (e.g., Internet) applications such as the hashtags used in Twitter, keywords used in search engines, trending terms in Facebook, TikTok, etc. can be paired with a value and thus subjected to a valuation. Any word, phrase, sentence or combination of letters, numbers or other symbols may be used to define a tag.

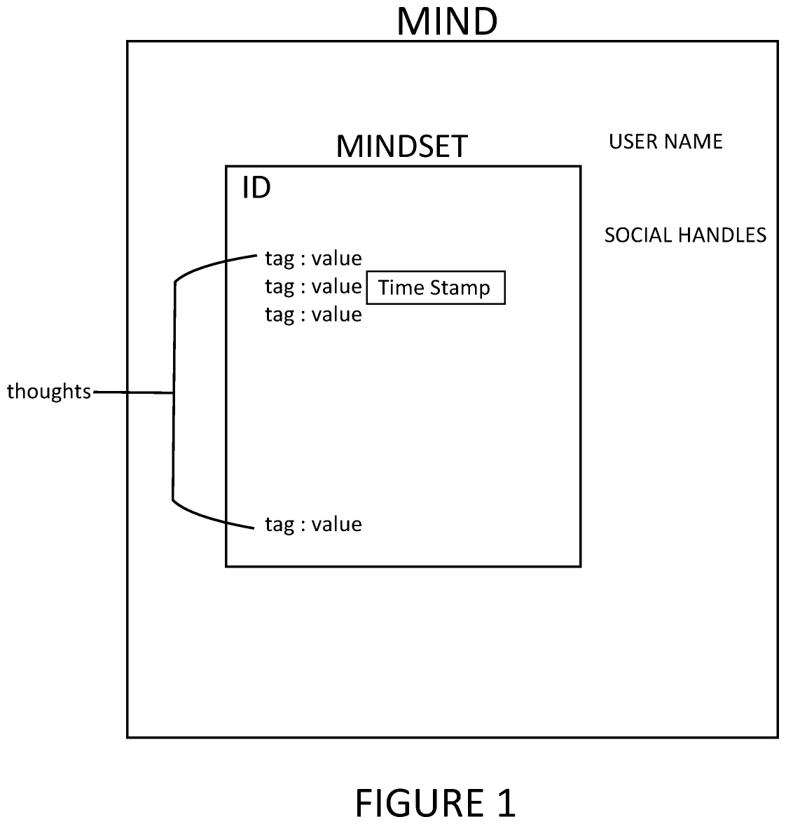

FIG. 1 illustrates examples of data records that can be used in various implementations. Naturally, the nomenclature is a matter of choice. And variations from the structures and actions described for these examples can be changed in different implementations.

FIG. 1 shows the overall data organization, referred to as a “mind.” A mind might be associated with a person, such as a user, or with another entity. Multiple people and/or entities can be associated with a single mind. Alternatively, a mind need not be associated with any person or entity and can still be used advantageously as explained below.

Each tag:value pair is referred to as a “thought.” There can be a few, or many, thoughts in a mindset as shown in FIG. 1. In practice, the number of thoughts in a mindset can vary from 1 or a few, to dozens, hundreds, thousands or more. An optional timestamp can be included with a thought and can be used, for example, to indicate when the thought was created, when the thought is to expire, or can be used for other reasons. In general, other types of values or information can be included in, or otherwise associated with, a thought data item. For example, thoughts can be organized into categories, or groups. The movie thought can be a category with associated sub-thought categories such as plot: 3, dialogue: 4, cinematography: 5, direction: 5, etc. Actors names can be listed in association with the movie name thought and each actor thought can be of the form actor_name: affinity_value. In cases where a thought has sub-thoughts, the top-category thought's affinity value can be automatically derived or computed from the values for the sub-thoughts. Other variations are possible such as where thoughts are grouped so that an affinity value that is changed for one thought causes the same value to be propagated to the other, grouped, thoughts.

The mindset can have an identification (ID), or some other way (e.g., a link) to point to, or otherwise refer to, the mind and/or mindset data structures.

If desired, additional data to identify a person or entity can be included in a mind. Thus a person's name, social media aliases (e.g., “handles”) or other information specifically used in association with a person or entity can be included. These may then be used to associate the mindset with the person or entity. Such associations may be useful to locate a mind by keyword searching. Or to know that the mind is created by, or provided from, a particular person or entity.

Users can search for existing tags, specify their own value for the tag, and then add the thought (i.e., tag:value) to their own mindset. Tags can also be searched by categories such as by looking in a database for thoughts/movies/horror/the_conjuring and adding the existing tag (“the_conjuring”) and user's value (e.g., user's affinity, or rating for “the_conjuring”) as a new thought in their mindset.

In various implementations, users can also create tagnames as they see fit and use them in their mindsets, pass them along to others to use, commit them to databases, etc. In this manner, a user can build up their mindset from several or many thoughts. Pre-existing mindsets can be used as a starting basis where the mindset can have thoughts that are relevant to a particular type of person. For example, pre-defined mindsets for “FPS Gamer,” “athlete,” “Non-Partisan Voter,” etc., can all be copied into a user's mindset to provide ready-made thoughts that the user can then change to better reflect the user's own thoughts. Mindset copies of favorite intellectuals, celebrities, politicians or others can be created and distributed to other users. A “weird” mindset might be created to allow a person to investigate arcane ideas, content or other information available online. One type of thought uses the “mindset_ID” tag with a value “learn” (i.e., mindset_ID: learn) to incorporate some or all of another mindsets thoughts. In other words, the value “learn” as applied to a mindset tag can algorithmically include all, or a portion of, of mindset_ID' s thoughts along with their values, into the mindset that is invoking the inclusion by use of the special command invoked by the format “mindset_ID:learn”.

Once a collection of mindsets is created they can be used to suggest thoughts to a particular user of the system. For example, a user can give the system a command to suggest movies that the user might like based on the user's own mindset. The system compares thoughts in the user's mindset with many of the other mindsets in the collection to find mindsets that are similar, or have “affinity,” or “commonality” to the user's mindset. This determination can be made by looking for matching tags and then comparing values for those tags. So, for example, if a user has several thoughts on different movies (either rated positively or negatively) then the system will search for those same tags in the other mindsets; identify similar mindsets as those that have a high correlation to the user's mindset; then look for occurrences of other movies in the thoughts of the similar mindsets that are not in the user's mindset and provide those other movie thoughts to the user (assuming they have a positive rating). Any other tags that don't have to do with movie titles can also be used in a mindset affinity search for movies, as such information may be useful (even more useful than mere movie ratings) in determining affinity among mindsets, and, thus, finding movies that the user may like.

In various implementations, users can adjust the matching criteria used in mindset affinity comparisons. For example, an exact value match is not necessary and the user might select a range or the system can do this automatically to provide more or less matches. The user can be shown the results of the affinity search and can be given an opportunity to adjust search parameters to eliminate types of mindsets based on any other suitable factors. For example, geographic area, tv show tag values, actor tag values, type of car tag values, or any desired type of thought can be used to filter results or perform sub-searches.

A user can use the search results to create additional thoughts to improve the results. For example, if a user wants horror movie recommendations but sees that a lot of violent or gory movies are being suggested rather than more psychologically scary movies they can add the names of the gory movies as thoughts in their mindset and give them a low, zero or negative rating and run the affinity search again.

In different implementations, the degree to which the user is provided with controls and options can vary. In a very automated system, the user need not actively deal with creating or filtering thoughts as the system can handle such decisions automatically and simply provide recommendations whenever the user logs in or otherwise accesses the system.

Once similar mindsets, or “like minds,” have been found, the system can recommend high-occuring thoughts from these like minds to the user automatically. For example, if many minds who like the same types of movies also have common thoughts on gardening then those gardening thoughts can be presented to the user and can identify people, entities or content online. These new thoughts that apply to the user can be added to the user's mindset automatically, or with the user's approval or filtering.

A like-mind that the user or the system decides might be particularly of-interest to the user can be “linked” to the user so that the actions of the person or entity associated with the like-mind are promoted to the user. For example, if a like-minded person posts information such as text, images, videos, etc., to the Internet, notification of these postings can be made to the user. This can be done regardless of what application, website, browser plug-in or other functionality is being used by the like-minded person to post the information. In other words, notifications to the user can be generated in response to all of the like-minded person's posts regardless of the destination of the posts.

Another implementation can filter online content that is not from like-minded sources. So, for example, as the user is viewing a social media site, any content from non-like-minded sources can be removed, obscured, flagged, or otherwise indicated as being undesirable. In an extreme implementation, only content from like-minded sources could be shown. The degree of like-mindedness affinity matching, and the actions taken as a result of the affinity matches, can vary across implementations. Many variations are possible.

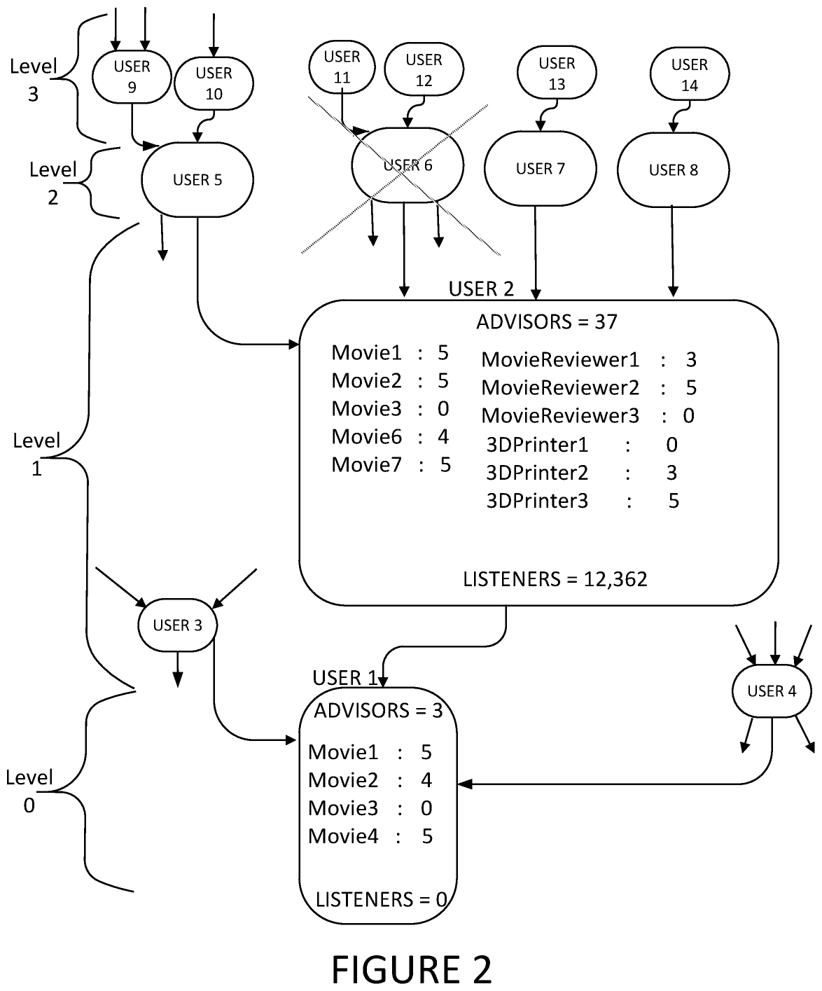

FIG. 2 illustrates several different mindsets and their relationships with each other. The mindset and other data can be stored and processed in the cloud or with Internet-based computing and storage. A human user's interaction with the system will typically be with personal computing devices such as a smartphone, tablet, laptop or other personal computing system.

User1 mindset is shown having thoughts of four movies with the example names “Movie1,” Movie2,” “Movie3” and “Movie4”. Also shown for User1 mindset is the number of advisor mindsets as “Advisors=3”. This means that User1 (a human user associated with User1 mindset) has accepted three other mindsets as sources of information, in the form of “thoughts.”

Details of User2 mindset are shown in FIG. 2. For ease of illustration, details of the other mindsets are not shown but the concepts presented in this example should make it clear that any of the mindsets in the system can include many different thoughts, different categories of thoughts, and other information as described herein.

User2 mindset includes thoughts on movie titles, similar to those in User1 mindset. However, the movie names and ratings are not exactly the same between User1 and User2. But in this case a criterion or algorithm is used that concludes that the tag:value pairs for User1 and User2 in the “movie” category is close enough (e.g., over a threshold, within a tolerance, etc.) so that the mindsets, at least with respect to the movie category, can be called similar or “like-minded.”

Having achieved this commonality, User1 can be presented with the option to accept User2 mindset as an “advisor” mindset. Note that there is additional data associated with the mindsets (as described above for a “mind”) but in order to simplify the discussion, the additional information is not shown or discussed in this example. In other embodiments, User1 need not have to manually approve advisor mindsets. The approval can be automatically determined by a default or user-selected parameter (such as requiring more or less mindset commonality, etc.).

Rejection of a mindset can also reject all listeners to that mindset. So, for example, this can weed out spam or marketing “fake” information where someone creates a mindset that has many popular movies rated highly but a couple promotional movies. In order to boost the mindset popularity rating the faker can also create many listeners to the spam mindset. But User1 can select to reject any mindset with the flawed movie in it and also the listeners to the rejected mindset (or the speakers to the rejected mindset, or both).

Once the user has accepted User2 mindset as an advisor, the system can parse other thoughts in User2 mindset and can (upon user selection or automatically) present high rated (or low rated, or some other measure of rating or description) thoughts to the user. Thus, in the example of FIG. 2, User2 mindset can be used to present the user associated with User1 mindset with recommendations for “MovieReviewer2” and “3DPrinter3” since they both have high ratings. In this manner, the user can be discover opinions or “thoughts” from like-minded others that the user has a likelihood of perceiving similarly.

In the example of FIG. 2, User1 mindset is a target, or key, mindset for discussion. User1 mindset is a new mindset so there are not yet any “Listeners,” where a listener of User1 mindset is a mindset that has accepted User1 mindset as an Advisor mindset. This means that the “listening” mindset receives notifications of common matchings and new thoughts in the advisor mindset. The degree to which the listening mindset is in communication with the advisor mindset can be varied by the user or by the system. Features described above, where postings of a user associated with an advisor mindset are automatically notified to the listening mindset, can be used.

On the other hand, User2 mindset is shown to have 12,362 listeners. The number of listeners can be used by the system and by the user to have an understanding of the popularity and, perhaps, reliability of User2 mindset—and any human user associated with User2 mindset. The listeners of User2 mindset can be tracked and presented to the user of User1 mindset—or can automatically be filtered or assigned—to gain further insight into User2 mindset. For example, further insight can include the number of listeners of User2 mindset that have commonality in the movies category. This could indicate that User2 mindset is being heavily relied-upon for movie-related thoughts. On the other hand, if a large number of User2 mindset's listeners have commonality in the 3DPrinter category it could indicate to a user that the User2 mindset is primarily being relied upon for 3D printing thoughts and is not primarily focused on movies or movie ratings. The user has the option to investigate and attempt mindset matches with User2 mindset's listeners. Such matching can be filtered by thought category, such as “movies” or “3D printing,” etc.

Potentially more important to the user associated with User1 mindset, however, is to analyze the Advisor mindsets of User2 mindset. If the user's interest is to find movie recommendations then it could be the case that a User2 advisor may have even more in common (or be a more effective source) than User2. This could be more likely because User2 has been in the system and active for a while based on the number of Listeners and Advisors.

Thus, User1 can perform matching requests on the advisors to User2. User1 can manually select advisors from this level 2 of the mindsets (advisors of an advisor). User1 can reject an advisor as shown by User6 mindset being crossed out. The type of user interface for accepting and rejecting advisors can be a graphical user interface that presents a chart or graph similar to what is shown in FIG. 2. Other types of data visualization can be used.

Level 3 shows 3^{rd} level advisors with respect to User1, where User1 is at a Level 0 and its immediate advisor mindsets are at Level 1. As mentioned, the details of the mindsets and the many other mindsets that would operate as advisors and/or listeners is not shown in FIG. 2.

Techniques described herein may be implemented by one or more generalized computing systems programmed pursuant to program instructions in firmware, local memory, local storage, networked storage, or a combination of these or other computer-readable media. Special-purpose computing devices may be used, such as desktop computer systems, portable computer systems, handheld devices, networking devices or any other device that incorporates hardware, software or other program logic to implement the techniques.

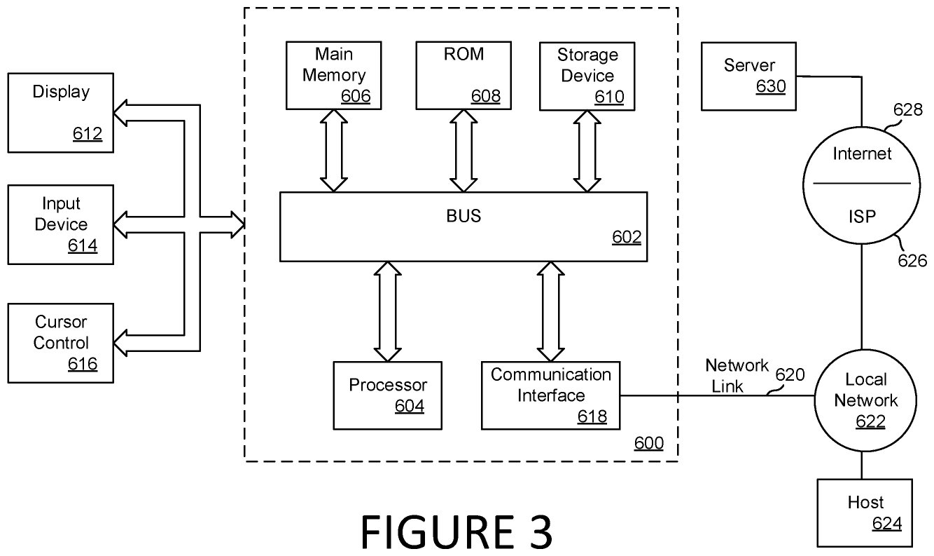

For example, FIG. 3 is a block diagram that illustrates basic components of an example computer system 600. In various implementations, different subsystems can be used. Subsystems can be modified and omitted from the example system. In general, any suitable combination of hardware and/or software can be used to implement techniques or features described herein. Computer system 600 includes a bus 602 or other communication mechanism for communicating information, and a processor 604 coupled with the bus 602 for processing information. The processor 604 may include, for example, a general purpose microprocessor, a CPU, a GPU, or any combination of the foregoing.

The computer system 600 also includes a main memory 606, such as a random access memory (RAM) or other dynamic storage device, coupled to the bus 602 for storing information and instructions to be executed by the processor 604. The main memory 606 may also be used for storing temporary variables or other intermediate information during execution of instructions to be executed by the processor 604. Such instructions, when stored in non-transitory storage media accessible to the processor 604, render the computer system 600 into a special-purpose machine that is customized to perform the operations specified in the instructions.

The computer system 600 further includes a read only memory (ROM) 608 or other static storage device coupled to the bus 602 for storing static information and instructions for the processor 604. A storage device 610, such as a magnetic disk, solid state drive (SSD), optical disk, etc., is provided and coupled to the bus 602 for transferring and storing information and instructions.

The computer system 600 may be coupled via the bus 602 to a display 612, such as a computer monitor, for displaying information to a computer user. An input device 614, including alphanumeric and other keys, is coupled to the bus 602 for communicating information and command selections to the processor 604. Another type of user input device is a cursor control 616, such as a mouse, a trackball, or cursor direction keys for communicating direction information and command selections to the processor 604 and for controlling cursor movement on the display 612. This input device typically has two degrees of freedom in two axes, a first axis (e.g., x) and a second axis (e.g., y), that allows the device to specify positions in a plane.

The computer system 600 may implement the techniques described herein using customized hard-wired logic, one or more ASICs or FPGAs, firmware and/or program logic which in combination with the computer system causes or programs the computer system 600 to be a special-purpose machine. According to one embodiment, the techniques herein are performed by the computer system 600 in response to the processor 604 executing one or more sequences of one or more instructions contained in the main memory 606. Such instructions may be read into the main memory 606 from another storage medium, such as the storage device 610. Execution of the sequences of instructions contained in the main memory 606 causes the processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as the storage device 610. Volatile media includes dynamic memory, such as the main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include the bus 602. Transmission media can also take the form of acoustic or light waves, such as those generated during radio-wave and infra-red data communications.

Various forms of media may be involved in carrying one or more sequences of one or more instructions to the processor 604 for execution. For example, the instructions may initially be carried on a magnetic disk or solid state drive of a remote computer. The remote computer can load the instructions into its dynamic memory and send the instructions over a network connection. A modem or network interface local to the computer system 600 can receive the data. The bus 602 carries the data to the main memory 606, from which the processor 604 retrieves and executes the instructions. The instructions received by the main memory 606 may optionally be stored on the storage device 610 either before or after execution by the processor 604.

The computer system 600 also includes a communication interface 618 coupled to the bus 602. The communication interface 618 provides a two-way data communication coupling to a network link 620 that is connected to a local network 622. For example, the communication interface 618 may be an integrated services digital network (ISDN) card, cable modem, satellite modem, or a modem to provide a data communication connection to a corresponding type of telephone line. Wireless links may also be implemented. In any such implementation, the communication interface 618 sends and receives electrical, electromagnetic, or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP) 626. The ISP 626 in turn provides data communication services through the world wide packet data communication network now commonly referred to as the “Internet” 628. The local network 622 and Internet 628 both use electrical, electromagnetic, or optical signals that carry digital data streams. The signals through the various networks and the signals on the network link 620 and through the communication interface 618, which carry the digital data to and from the computer system 600, are example forms of transmission media.

The computer system 600 can send messages and receive data, including program code, through the network(s), the network link 620, and communication interface 618. In the Internet example, a server 630 might transmit a requested code for an application program through the Internet 628, ISP 626, local network 622, and communication interface 618. The received code may be executed by the processor 604 as it is received, and/or stored in the storage device 610, or other non-volatile storage for later execution.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for automating transfer of thoughts, the method comprising:
creating a first mindset with a plurality of thoughts, wherein each thought includes a tag:value pair;
matching the first mindset with a second mindset, wherein the second mindset has a commonality with at least a portion of the first mindset's thoughts;
identifying advisor mindsets of the second mindset, wherein an advisor mindset includes at least one commonality of thoughts with the second mindset;
accepting a signal from a user input device to permit a user associated with the first mindset to selectively accept or reject the advisor mindsets; and
using the accepted advisor mindsets to refer thoughts to the user.

2. The method of claim 1, wherein the referred thoughts are in a same category as the first mindset's plurality of thoughts.

3. The method of claim 1, wherein the referred thoughts are in a different category from the first mindset's plurality of thoughts.

4. The method of claim 1, further comprising:
including a timestamp in association with at least one tag:value pair.

5. The method of claim 4, wherein the timestamp indicates a date of creation of the tag:value pair.

6. The method of claim 4, wherein the timestamp indicates a date of modification of the tag:value pair.

7. The method of claim 4, wherein the timestamp indicates an expiration of at least a part of the tag:value pair.

8. An apparatus configured to perform the acts of claim 1.

9. A non-transitory processor-readable medium including instructions which, when executed by one or more processors, perform the acts of claim 1.
